(19) United States
(12) Patent Application Publication
(10) Pub. No.: US 2015/0260987 A1
(43) Pub. Date: Sep. 17, 2015

(54) FIELD-OF-VIEW DISPLAY FOR A VEHICLE

(71) Applicant: ROBERT BOSCH GMBH, Stuttgart (DE)

(72) Inventors: Jan Weingarten, Gerlingen (DE); Sascha Steinkogler, Freiburg (DE)

(21) Appl. No.: 14/432,053

(22) PCT Filed: Sep. 20, 2013
(86) PCT No.: PCT/EP2013/069559

§ 371 Date: Mar. 27, 2015

(30) Foreign Application Priority Data
Oct. 9, 2012 (DE) 10 2012 218 360.4

(51) Int. Cl. G02B 27/01

(52) U.S. Cl. CPC G02B 27/0101; G02B 2027/0123; G02B 2027/0145; G02B 2027/015

(57) ABSTRACT

A field-of-view display for a vehicle for displaying image information in line of sight of a vehicle occupant, in which optical elements are configured to form a beam volume carrying the image information and having an intermediate focus operative in one direction in space.

### FIELD OF THE INVENTION

The present invention relates to a field-of-view display for a vehicle.

### BACKGROUND INFORMATION

A field-of-view display is a display unit with which information is able to be faded into a field of view of an occupant of a vehicle. For example, information of a driver assistance system may be faded into the view of the driver. Field-of-view displays are also known as head-up display or HUD for short. A field-of-view display illuminates a transparent surface or window area with the image of information, so that the imaging light of the information is reflected into the eyes of a viewer who is looking through the transparent surface. Compared to a conventional display via an instrument panel, field-of-view displays offer the advantage that the viewer does not have to turn his eye away from a real traffic situation in order to acquire the information conveyed with the aid of the field-of-view display.

A further advantage is that the driver does not have to refocus between the driving scene and the HUD image content. When reading, the focal distance of the individual eyes of the driver remains almost at infinity. The advantages indicated are leading to the ever greater prevalence of field-of-view displays. In order to display contact-analog functions in the field-of-view display, imaging optics are needed which realize a larger field of view (e.g., 8°×5°) compared to conventional field-of-view displays and a greater image distance (e.g., >10 m). The result is that the number of optical elements and the optical path increase. Because of an enlarged optical path and a higher number of optical elements, the field-of-view display requires more space.

The German Patent 10 2007 047232 A1 discusses a field-of-view display for a motor vehicle having a projection unit including an image generator for generating a virtual image and a combiner for viewing the virtual image.

Patent document DE 3879044 T2 discusses optical systems for field-of-view displays for projecting a collimated image of an object, for instance, information displayed on the screen of a cathode ray tube, to the outer visual field of an aircraft pilot, for example, and is especially applicable in those systems which use an optical relay for forming an intermediate image of the object in the focal plane of a collimating lens or a collimating mirror.

### SUMMARY OF THE INVENTION

Against this background, the present invention introduces a field-of-view display for a vehicle according to the main claim. Advantageous refinements are yielded from the dependent claims and the following description.

An intermediate focus between two optical elements of a field-of-view display is able to reduce the space required by the field-of-view display. When an intermediate focus operative in two directions in space leads to imaging errors, they are able to be corrected by further optical elements. When the intermediate focus is operative only in one direction in space, the demands on the optical elements decrease. In particular, the number of imaging errors decreases, accompanied at the same time by maximum space gain in one direction, especially in the vertical direction. In comparison to conventional field-of-view displays, contact-analog field-of-view displays are able to have a larger field of view, which may lead to a greater number of optical elements and a larger required space. An intermediate focus would provide a solution here for reducing the space required.

A field-of-view display for a vehicle for the display of image information in the line of sight of a vehicle occupant is described, the field-of-view display having the following features:

Optical elements, which are configured to form a beam volume carrying the image information and having an intermediate focus operative in one direction in space.

A vehicle is able to have a field-of-view display. The vehicle may be a motor vehicle, particularly a passenger car, a commercial vehicle or a rail vehicle. The field-of-view display may also be referred to as head-up display or HUD. A field-of-view display may also be understood to be a field-of-view presentation device, or alternatively, a line-of-sight display. A field-of-view display may be understood to be a display unit with which in a vehicle, information in the form of image information, e.g., information of a driver assistance system, is able to be faded into the line of sight of a vehicle occupant. The field-of-view display may have at least two optical elements. The field-of-view display may have a projection surface. The projection surface may be referred to as a combiner. A transparent vehicle element, e.g., a windshield, may be used as projection surface. A projection surface may also be referred to as a combiner of information. A projection surface may be a specular, light-transmitting element. The projection surface is able to superimpose or combine information concerning the surroundings with the image information, that is, artificially generated information. A field-of-view display may have a projection unit having an image generator for generating the image information as virtual image and a projection surface for viewing the virtual image, the at least two optical elements being disposed in the beam path between the image generator and the projection surface.

The vehicle occupant may be a driver and simultaneously or alternatively, a front-seat passenger of the vehicle. Optical elements may be understood to be an arrangement for conducting light. An optical element may be implemented to be light-transmitting or reflective, e.g., as a lens, a mirror or a diffraction element. Light beams are able to be conducted from an image generator through the optical elements onto a projection surface. The optical elements may be referred to in total as optics module. The properties of the optical elements may be those of a collimator, and at the same time or alternatively, those of a deflector. The optical elements are able to conduct a beam volume carrying the image information from an image generator to a projection surface. A maximum spatial spreading of light beams which are conducted through the optical elements may be referred to as beam volume. Intermediate focus may be understood to be a focusing of the beam volume between two optical elements.

According to one specific embodiment of the present invention, the intermediate focus may be perpendicular to the optical axis of the field-of-view display in the area of the intermediate focus. The straight line which is formed by the axes of the individual optical elements may be referred to as optical axis and may correspond with the axis of symmetry of the individual optical elements. Strictly speaking, in the case of the use of a windshield as projection surface, the optical systems are not really symmetrical. Except for folding mirrors, the mirrors used in this context are mostly free-form optics. When using a separate combiner as projection surface, the systems are usually axisymmetric.

It is also beneficial if, in one specific embodiment, the field-of-view display is implemented as a contact-analog field-of-view display. Contact-analog information may be taken to mean display elements of a contact-analog field-of-view display, which are faded into the instantaneous view of a vehicle occupant as though they were a solid component of the environment. For example, a navigation arrow may appear as though it were lying directly on the road.

In one specific embodiment, the intermediate focus may be elongated. The intermediate focus may thus represent an area whose length is greater than its width. This may be achieved by a suitably formed optical element. For instance, the area of the intermediate focus may be oval or rectangular.

In this context, the elongated intermediate focus may have a main extension direction which is aligned parallel to the main extension direction of the image information. The image information may have an essentially rectangular outer form.

The optical elements may be implemented to be reflective. The optical elements may be implemented to be refractive. The optical elements may be implemented to be diffractive. The optical elements may be reflective and simultaneously or alternatively refractive and simultaneously or alternatively diffractive. The optical elements may be referred to in total as an optical system.

The intermediate focus may be formed exclusively in one direction in space. The direction in space may be oriented perpendicular to the optical axis. This may be taken to mean that because of the intermediate focus, the image information is subject to an axial reflection. In this context, a mirror axis of the axial reflection may be aligned perpendicular to the direction in space and perpendicular to the optical axis.

For example, such an intermediate focus may be produced by a cylindrical optical element.

In addition, according to one specific embodiment, the intermediate focus may be formed exclusively in the sagittal plane. Alternatively, the intermediate focus may be formed exclusively in the meridian plane.

The field-of-view display may further have an image generator for generating the image information and a projection surface for viewing the virtual image, the at least two optical elements being disposed in the beam path between the image generator and the projection surface. The image generator and the projection surface may be referred to as a display arrangement. The image generator may take the form of a projection unit. The image information generated by the image generator becomes the virtual image, viewed via the optical system and the projection surface. In this sense, the image generator “generates” no virtual image, but rather only the image generator together with the optical system.

The field-of-view display may have at least one further optical element. The at least one further optical element may be reflective. A reflective optical element is able to bend the beam path of the field-of-view display and permit a more compact type of construction. In another specific embodiment, the field-of-view display may have at least a third optical element, the at least one additional optical element being reflective. A specific embodiment having a fourth reflective optical element is also able to achieve a beneficial and, at the same time or alternatively, more compact type of construction.

The display of contact-analog information may necessitate a larger field of view in comparison to conventional field-of-view displays, and along with that, a greater number of optical elements. For this reason, the imaging optics of a contact-analog field-of-view display (contact-analog head-up display or caHUD) may demand a markedly greater volume than a conventional field-of-view display. In order to avoid collisions with other units in the instrument panel, especially with the steering column, the air conditioner, the ventilation hoses, etc., the space needed for a contact-analog field-of-view display may be reduced by increasing the image scale and thereby shortening the optical path. However, assuming the number of optical elements remains the same, the image quality may thereby decrease. Moreover, a high image scale (>20) may lead to high requirements in terms of surface quality and tolerances.

The use of the intermediate focus would provide a solution to avoid this and nevertheless to minimize the beam volume of a multi-element imaging system. In order to prevent the intermediate focus from having an effect on the image quality, the sharper surface curvature necessary to realize the intermediate focus may be offset again. In this context, it may be taken into account that because of the rectangular aspect ratio of the field-of-view display image and the eyebox, the surface curvature realizing the intermediate focus turns out to be significantly sharper along the longer image extension than along the shorter axis. If this leads to image errors, they may be offset by further optical elements.

According to one specific embodiment, an intermediate focus, operative only in one direction in space, perpendicular to the direction of propagation of the light is used. In this instance, the intermediate focus may be elongated and, in terms of its longitudinal axis, may be aligned parallel to the longer extension of the field-of-view display image. The intermediate focus may thus be realized in the sagittal plane or the meridian plane, but not in both planes simultaneously.

That is to say, the additional surface curvature needed to realize the intermediate focus is effected only along the shorter extension of the optical elements, which means the additionally arising image errors mentioned above are able to be kept small. Moreover, the space gain in the vertical direction is able to be maximal, thereby making it possible to avoid a collision with the steering column. Very compact contact-analog field-of-view displays are able to be realized using this method.

In the following, the invention is explained in detail by way of example with reference to the attached drawings.

### BRIEF DESCRIPTION OF THE DRAWINGS

FIG. 1 shows a schematic representation of a field-of-view display in a vehicle according to one exemplary embodiment of the present invention.

FIG. 2 shows a schematic representation of a field-of-view display according to one exemplary embodiment of the present invention.

FIG. 3 shows a schematic representation of optical elements of a field-of-view display.

FIG. 4 shows a schematic representation of optical elements of a field-of-view display according to one exemplary embodiment of the present invention.

FIGS. 5a and 5b show a schematic representation of optical elements of a field-of-view display according to one exemplary embodiment of the present invention.

FIG. 6 shows an optical system for a contact-analog field-of-view display according to one exemplary embodiment of the present invention.

FIG. 7 shows a contact-analog field-of-view display according to one exemplary embodiment of the present invention.

FIG. 8 shows a contact-analog field-of-view display according to one exemplary embodiment of the present invention. and

FIG. 9 shows a contact-analog field-of-view display according to one exemplary embodiment of the present invention.

### DETAILED DESCRIPTION

In the following description of exemplary embodiments of the present invention, the same or similar reference symbols are used for the similarly functioning elements shown in the various figures, a repeated description of these elements being omitted.

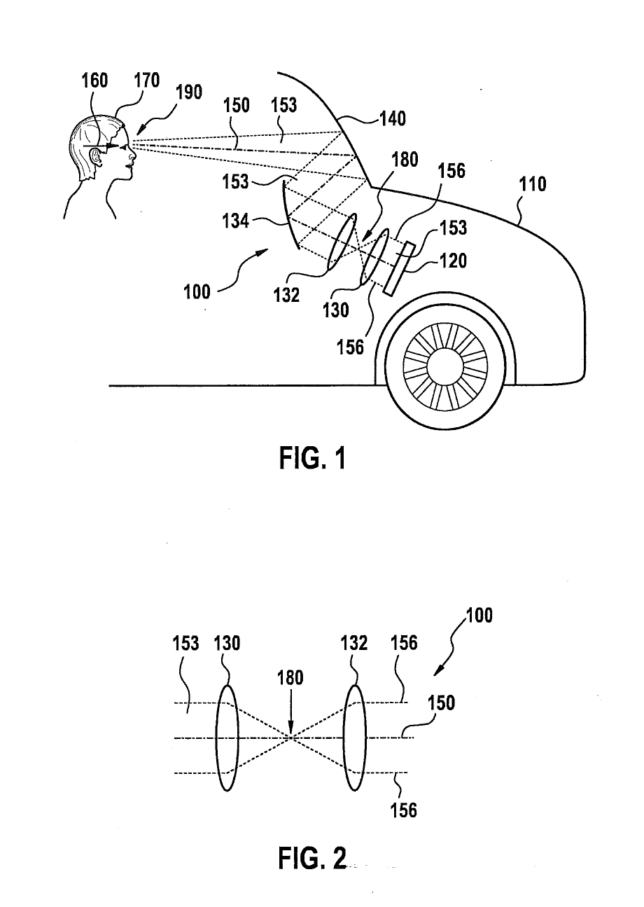

FIG. 1 shows a schematic representation of a field-of-view display 100 in a vehicle 110 according to one exemplary embodiment of the present invention. Field-of-view display 100 is disposed as a head-up display in vehicle 110. Field-of-view display 100 shown includes an image generator 120, a first optical element 130, a second optical element 132 and a third optical element 134, and uses a windshield 140 of vehicle 110 as projection surface. Windshield 140 is a specular, light-transmitting window glass.

Field-of-view display 100 has an optical axis 150. Image generator 120 is configured to provide image information which is projected in a beam volume 153, that is bounded by edges 156 of beam volume 153, into line of sight 160 of a vehicle occupant 170. Between first optical element 130 and second optical element 132, the field-of-view display has an intermediate focus 180. The image information is visible for vehicle occupant 170 in the area of eyebox 190. Vehicle occupant 170 sees the information of the image generator as imaging unit mirrored in windshield 140, and at the same time, the real world behind windshield 140.

FIG. 2 shows a schematic representation of a portion of a field-of-view display 100 according to one exemplary embodiment of the present invention. Field-of-view display 100 has two optical elements 130, 132. Optical elements 130, 132 may be first optical element 130 and second optical element 132 shown in FIG. 1. Optical elements 130, 132 form an optical axis 150. A beam volume 153 carries image information. Beam volume 153 is bounded by edges 156. Optical elements 130, 132 are configured to form beam volume 153 with an intermediate focus 180 operative in one direction in space. Intermediate focus 180 lies on optical axis 150 of optical elements 130, 132, that is to say, intermediate focus 180 lies on optical axis 150 of field-of-view display 100.

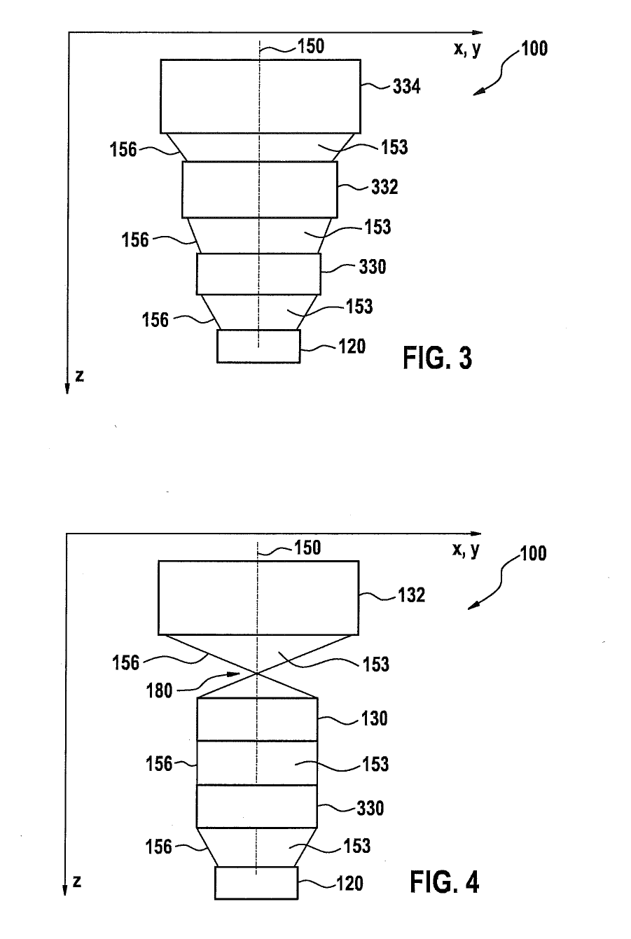

FIG. 3 shows a schematic representation of optical elements 330, 332, 334 of a field-of-view display 100, which form a beam volume 153. Three optical elements 330, 332, 334 form beam volumes 153. An image generator 120 is configured to provide an image to be projected on a projection surface. The image to be projected is imaged by the optical elements of field-of-view display 100. Optical elements 330, 332, 334 define an optical axis 150. Optical axis 150 corresponds to or rather is parallel to the z-axis shown. The light emitted by image generator 120 propagates in the negative z-axis direction. An x-axis and a y-axis define an area perpendicular to the z-axis. The x-axis and the y-axis are shown superimposed, since the view of the optical system matches from both sides. Beam volumes 153 have no intermediate focus. In other words, FIG. 3 shows beam volume 153, formed by optical elements 330, 332, 334, of a conventional field-of-view display without intermediate focus. In this context, optical elements 330, 332, 334 may be implemented to be both reflective, refractive and diffractive. Image generator 120 represents the display which generates the real image that is imaged by the optical system of the field-of-view display. The z-axis corresponds to optical axis 150, the light propagates in the negative z-axis direction. The x-axis and the y-axis define the surface perpendicular to that. The imaging function of conventional field-of-view display 100 is realized without an intermediate focus. Shown edges 156 of beam volumes 153 do not intersect.

FIG. 4 shows a schematic representation of optical elements 130, 132, 330 of a field-of-view display 100, which form a beam volume 153 having an intermediate focus 180 operative in two directions in space, according to one exemplary embodiment of the present invention. The depiction in FIG. 4 corresponds largely to the depiction in FIG. 3, with the difference that between third optical element 132 and second optical element 130, an intermediate focus 180, operative in the x-direction and in the y-direction, is realized and shown. In this manner, image information relayed between optical elements 130, 132 may be subject at least approximately to a point reflection (symmetry). Beam volume 153 is bounded by edges 156. Beam volume 153 expands between image generator 120 and first optical element 330. Edges 156 of beam volume 153 run in parallel between first optical element 330 and second optical element 130. An intermediate focus 180 is formed between second optical element 130 and third optical element 132. Edges 156 of beam volume 153 between second optical element 130 and third optical element 132 intersect in intermediate focus 180. In the ideal case, edges 156 of beam volume 153 intersect in intermediate focus 180 at one point. The point at which edges 156 of beam volume 153 intersect in intermediate focus 180 lies on optical axis 150 of optical elements 130, 132, 330. In another exemplary embodiment, the cross-sectional area of beam volume 153 in intermediate focus 180 is circular. In other words, FIG. 4 shows the optical path of an optical system of a field-of-view display having intermediate focus 180, which is realized, by way of example, between third optical element 132 and second optical element 130. Intermediate focus 180 is realized both in the x-direction and in the y-direction. Ideally, the cross-sectional area of beam volume 153 would look punctiform to circular at the location of intermediate focus 180.

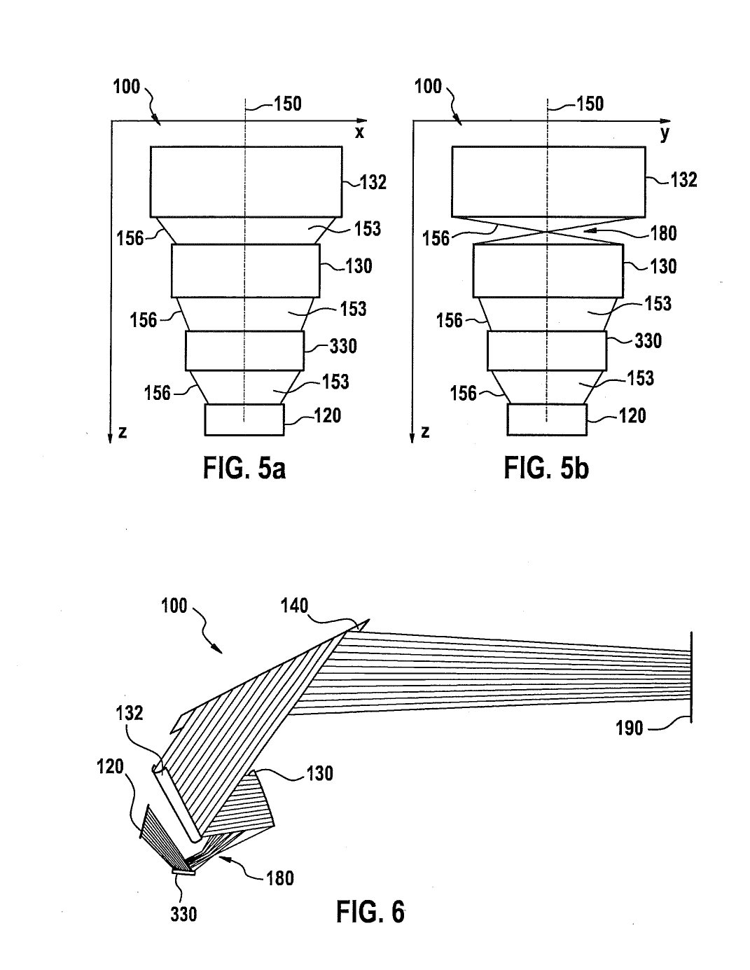

FIGS. 5a and 5b show a schematic representation of optical elements 130, 132, 330 of a field-of-view display 100, which form a beam volume 153 having an intermediate focus 180 operative in one direction in space, according to one exemplary embodiment of the present invention. In addition to the z-axis, FIG. 5a shows the x-axis aligned perpendicular to the z-axis. In addition to the z-axis, FIG. 5b shows the y-axis aligned perpendicular to the z-axis. FIG. 5b is able to show a lateral view of the field-of-view display depicted in FIG. 5a. Three optical elements 130, 132, 330 form beam volumes 153. Beam volumes 153 are bounded by edges 156. Optical elements 130, 132, 330 define an optical axis 150. Optical axis 150 corresponds to or rather is parallel to the z-axis shown. An image generator 120 is configured to provide an image to be projected on a projection surface. The image to be projected is imaged by optical elements 130, 132, 330 of field-of-view display 100. The light emitted by image generator 120 propagates in the negative z-axis direction. The x-axis and the y-axis define an area perpendicular to the z-axis, that is, the x-axis shown in FIG. 5a is perpendicular to the y-axis shown in FIG. 5b. In FIG. 5a, no intermediate focus 180 is to be seen between the optical elements. In FIG. 5b, an intermediate focus 180 is seen between second optical element 130 and the third optical element. The combination of FIG. 5a and FIG. 5b shows an intermediate focus 180, operative in only one direction in space, between second optical element 130 and third optical element 132. In other words, FIG. 5a and FIG. 5b show an optical system in which an intermediate focus 180 is realized only in one direction, by way of example, in the y-direction. In this case, the cross-sectional area of beam volume 153 at intermediate focus 180 looks rectangular. Due to an intermediate focus operative only in one direction in space, image information, i.e., the image to be projected, relayed between optical elements 130, 132 may be subject to an axial reflection.

For example, an intermediate focus as shown in FIGS. 4, 5a and 5b may be used in a field-of-view display 100 as described on the basis of FIG. 1.

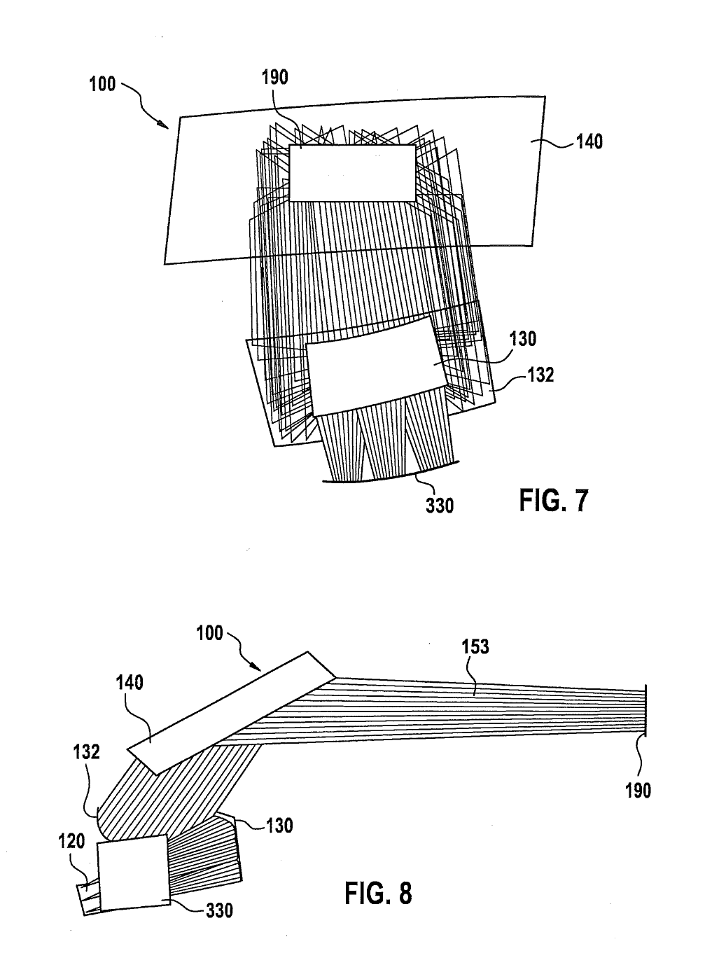

FIG. 6 shows an exemplary embodiment of an optical system for a contact-analog field-of-view display 100 according to one exemplary embodiment of the present invention. An image generator 120 produces an image which is represented by three optical elements 130, 132, 330 in the direction of an eyebox 190. Optical elements 130, 132, 330 form beam volumes between optical elements 130, 132, 330. In the exemplary embodiment, optical elements 130, 132, 330 are in the form of reflective optical elements 130, 132, 330. Between first optical element 330 and second optical element 130, an intermediate focus 180 is formed which is operative in one direction in space. The light beams are directed by third optical element 132 to a projection surface 140, which is a windshield 140 in the exemplary embodiment. From there, the light beams are directed into eyebox 190. “Directing” is to be understood here to be a refraction and/or a reflection. As in the case of the exemplary embodiments shown in FIGS. 5a and 5b, the intermediate focus is operative only in the direction in space of the y-axis. In other words, FIG. 6, as well as the following FIG. 7, shows a real implementation of a contact-analog optical configuration, that is, an optical configuration of a contact-analog field-of-view display, in which such an intermediate focus 180 was realized in one direction.

FIG. 7 shows an exemplary embodiment of a contact-analog field-of-view display 100 according to one exemplary embodiment of the present invention. Field-of-view display 100 has three optical elements 330, 130, 132. Image information provided by an image generator becomes visible in an eyebox 190 via a windshield 140, which is used as projection surface. In one exemplary embodiment, eyebox 190 may be adjusted to a seating position of a vehicle occupant.

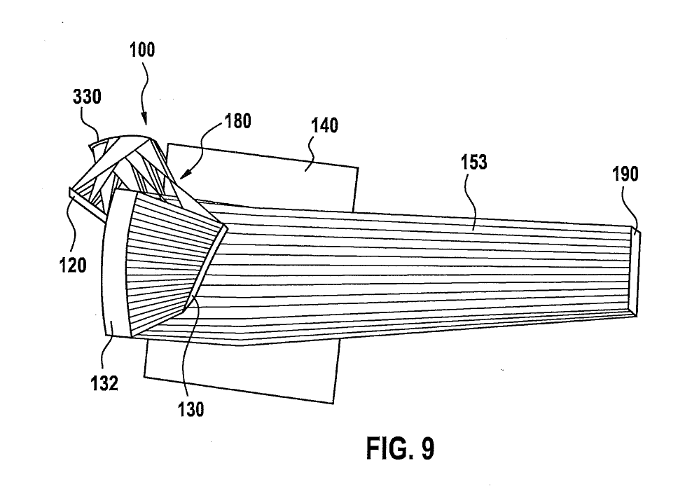

FIG. 8 and FIG. 9 show a contact-analog field-of-view display 100 according to one exemplary embodiment of the present invention. FIG. 8 shows a lateral view and FIG. 9 shows a view of the same contact-analog field-of-view display 100 from below. Field-of-view display 100 has an image generator 120 as well as three optical elements 130, 132, 330. A windshield is used as projection surface 140. The image information provided by image generator 120 in a beam volume 153 becomes visible for a vehicle occupant in an eyebox 190. In other words, FIGS. 8 and 9 show a further exemplary embodiment of an optical configuration having intermediate focus 180 in one direction. In this context, the number of optical elements 130, 132, 330 may vary. FIG. 8 and FIG. 9 show a further exemplary embodiment for a field-of-view-display optical system having intermediate focus 180 in the y-direction. In this case, FIG. 8 shows a lateral view and FIG. 9 shows a view from below.

The exemplary embodiments described and illustrated in the figures are selected only by way of example. Different exemplary embodiments may be combined with each other completely or in terms of individual features. One exemplary embodiment may also be supplemented by features from another exemplary embodiment.

1-10. (canceled)

11. A field-of-view display, for a vehicle, for displaying image information in a line of sight of a vehicle occupant, comprising:
an optical element arrangement having optical elements to form a beam volume carrying the image information and having an intermediate focus operative in one direction in space.

12. The field-of-view display of claim 1, wherein the intermediate focus is perpendicular to an optical axis of the field-of-view display in the area of the intermediate focus.

13. The field-of-view display of claim 1, wherein the display includes a contact-analog field-of-view display.

14. The field-of-view display of claim 1, wherein the intermediate focus is elongated.

15. The field-of-view display of claim 1, wherein the intermediate focus has a main extension direction that is aligned parallel to the main extension direction of the image information.

16. The field-of-view display of claim 1, wherein the optical elements are at least one of reflective, refractive and diffractive.

17. The field-of-view display of claim 1, wherein the intermediate focus is formed exclusively in one direction in space.

18. The field-of-view display of claim 1, wherein the intermediate focus is formed exclusively (i) in the sagittal plane, or (ii) in the meridian plane.

19. The field-of-view display of claim 1, further comprising:
an image generator for generating the image information and a projection surface for viewing the virtual image, wherein the at least two optical elements are disposed in the beam path between the image generator and the projection surface.

20. The field-of-view display of claim 1, further comprising:
at least one further optical element, which is reflective.
